(19) United States
(12) Patent Application Publication
(10) Pub. No.: US 2017/0033620 A1
(43) Pub. Date: Feb. 2, 2017

(54) STATOR FOR A ROTARY ELECTRIC MACHINE

(71) Applicant: MOTEURS LEROY-SOMER, Angouleme (FR)

(72) Inventor: Jacques SAINT-MICHEL, Angouleme (FR)

(73) Assignee: MOTEURS LEROY-SOMER, Angouleme (FR)

(21) Appl. No.: 15/303,261

(22) PCT Filed: Apr. 9, 2015
(86) PCT No.: PCT/IB2015/052590

§ 371 Date: Oct. 11, 2016

(30) Foreign Application Priority Data
Apr. 10, 2014 (FR) 14 53217

(51) Int. Cl. H02K 1/16; H02K 1/27

(52) U.S. Cl. CPC H02K 1/165; H02K 1/27

(57) ABSTRACT

A stator for a rotary electric machine has: a toothed ring with teeth defining notches therebetween, the notches being open radially toward the outside, windings, which are arranged in a distributed manner in the notches, electrical conductors being arranged in an aligned manner in the notches, and a yoke mounted onto the toothed ring.

The present invention relates to rotary electric machines, notably synchronous motors, and more particularly to the stators of such machines.

The invention is concerned more particularly with stators having distributed windings. In such stators, the windings are distributed in slots in a toothed yoke, with outbound and return electrical conductors that are each housed in different and non-consecutive slots, as described for example in patent application FR 2 801 142, which relates, however, to a wound-rotor motor or a squirrel cage motor.

In the known stators, the yoke is toothed, forming slots that are completely open or half-open in the direction of the air gap, so as to allow the windings to be introduced. Generally, the half-open slots may receive electrical conductors with a circular cross section that are disposed loosely, while the open slots may receive electrical conductors with a rectangular cross section that are disposed in an arranged manner.

However, the slot openings in the direction of the air gap may produce non-negligible electromagnetic disturbances, notably an increase in the “magnetic” air gap on account of flux fringing, higher iron losses at the surface of the rotor for the same reason, or pulsating torques since the variations in permeance are relatively abrupt.

Therefore, there is a need to benefit from a stator of a rotary electric machine that allows easy and effective filling of the slots, while ensuring better electromagnetic performance.

The invention aims to meet all or part of this need and achieves this, according to one of its aspects, by virtue of a stator of a rotary electric machine, comprising:

a ring gear having teeth that define slots between one another that are open radially toward the outside,

windings that are disposed in a distributed manner in the slots, having electrical conductors that are disposed in an arranged manner in the slots, and

a yoke attached to the ring gear.

The term “distributed” means that at least one of the windings passes through two non-adjacent slots in succession.

The term “attached yoke” should be understood as meaning that the yoke is not produced in one piece with the ring gear but is fastened to the latter while the stator is being manufactured.

The term “arranged” means that the electrical conductors are not disposed loosely in the slots but in an ordered manner. They are stacked in the slots in a non-random manner, being disposed for example in rows of aligned electrical conductors. The stack of electrical conductors may be for example a stack forming a hexagonal array in the case of electrical conductors having a circular cross section.

The fitting of the windings may be rendered easier both in that access to the interior of the slots is easier, since they are slots that are open more extensively in the direction of the outside rather than toward the air gap, and in that the space available around the ring gear, for the necessary tools or even for a winding machine, is much larger than the space available in the bore of the stator. Furthermore, the winding operation is relatively inexpensive, inasmuch as it may be carried out in a similar manner to the winding of a rotor of a DC motor or of a wound-rotor induction motor.

Moreover, a stator in accordance with the invention has numerous advantages from an electromagnetic point of view. It makes it possible to greatly reduce electromagnetic disturbances linked to the presence of the slots and also the magnetic noise. Moreover, since it is easier to fill the slots, the filling rate may be improved, and this may make it possible to further improve the performance of the machine. The torque per unit volume may notably be increased, and it is possible to reduce the rating of the electronic variator or increase the efficiency.

Finally, the cost of manufacturing the stator may be reduced, given that the necessary quantity of magnetic laminations may be smaller.

The ring gear is formed by the set of teeth of the stator that are joined together at their base on the air gap side. The teeth are joined together by tangential bridges.

At least one slot may be closed on the air gap side by a tangential bridge that connects two consecutive teeth of the ring gear together, better still all the slots may each be closed on the air gap side by a tangential bridge that connects two consecutive teeth of the ring gear together. The tangential bridge or bridges have a constant width. In a variant, the tangential bridge or bridges may have a width that decreases and then increases.

At least one slot, better still all the slots, may have mutually parallel radial edges.

At least one slot may have a shape chosen from the following list in cross section, perpendicularly to the axis of rotation: rectangular, hexagonal; this list not being limiting. Preferably, at least one slot has, in cross section, a bottom that narrows in the direction of the air gap, notably having a hexagonal shape. Preferably, the shape of the slot corresponds to the shape of the stack of electric conductors disposed therein, it being possible for this to be the case notably when the slot has a hexagonal cross section. Moreover, the tangential bridges in this case have a non-constant width, which decreases and then increases linearly. Such a configuration of the tangential bridges makes it possible to minimize harmonics, to obtain more torque by desaturation of the teeth and of the yoke, and to improve heat transfers.

At least one tooth, better still all the teeth, may have a trapezoidal overall shape in cross section.

The electrical conductors in the slots may have a circular, or polygonal, notably rectangular, shape in cross section, this list not being limiting. When the conductors have a circular cross section, they may be disposed in the slot in a hexagonal stack. When the conductors have a rectangular cross section, they may be disposed in the slot in a single row, being adjacent to one another with their long sides. The optimization of the stack may make it possible to dispose a greater quantity of electrical conductors in the slots, and, in parallel therewith, to reduce the useful area of the slot, and therefore to obtain in this way a more powerful stator having a constant volume.

The ring gear may be produced by helically winding up a rectilinear strip of teeth connected by tangential bridges, the teeth of the rectilinear strip forming slots between one another that have convergent edges, the edges of the slots becoming substantially parallel to one another when the strip is wound up on itself to form the ring gear. In a variant, the strip may be formed of sectors that each have several teeth, the sectors being connected by material bridges, these sectors being cut out of a rectilinear metal strip.

The yoke may likewise be produced in a similar manner, either by helically winding up a metal strip directly, if the width thereof allows, or by forming suitable slots in said metal strip during cutting, so as to make this winding up operation easier.

The yoke may be attached to the ring gear after the windings have been fitted in the slots.

Machine and Rotor

A further subject of the invention is a rotary electric machine, such as a synchronous motor or a synchronous generator, comprising a stator as defined above. The machine may be a reluctance motor. It may constitute a synchronous motor.

The machine may operate at a nominal peripheral speed (tangential speed measured at the outside diameter of the rotor) which may be greater than or equal to 100 meters per second. Thus, the machine according to the invention allows operation at high speeds, if so desired.

The rotary electric machine may comprise a permanent magnet rotor.

The machine may have a relatively large size. The diameter of the rotor may be greater than 50 mm, better still greater than 80 mm, being for example between 80 and 500 mm.

The rotor may have a rotor magnetic mass and at least two permanent magnets defining a pole of the rotor, the two permanent magnets being disposed on either side of a radial axis Y of said pole in a common housing which is formed in the rotor magnetic mass and through which the radial axis Y of the pole passes. In one exemplary embodiment of the invention, the two permanent magnets are each disposed entirely on one and the same side of the radial axis of the pole. Since the two permanent magnets are disposed in a common housing, the rotor does not have a magnetic material bridge extending between these two magnets and short-circuiting the flux of the magnets, and so magnetic leakage may be reduced thereby.

The term “radial axis of the pole” denotes an axis Y of the pole that is oriented radially, that is to say along a radius of the rotor. It may be an axis of symmetry of the pole. This radial axis may intersect the apex of the pole.

A housing may be U-shaped or V-shaped.

For one and the same pole, the rotor may comprise at least two housings, one housing having lateral branches parallel to the lateral branches of the other housing.

The rotor magnetic mass may comprise at least one pole piece connected to the rest of the magnetic mass by tangential bridges that are formed between each of the two ends of the housing and the radially outer surface of the rotor.

It is possible for the rotor not to have any material bridges other than tangential material bridges. The term “tangential bridge” denotes a material bridge formed between a housing and the air gap. This may allow a considerable improvement in electromagnetic performance.

The magnets of a housing may be disposed in a manner set back from the corresponding tangential bridges, and may not be in contact with the latter.

The absence of radial magnetic bridges between the two permanent magnets may reduce the mechanical strength of the rotor. If the rotational speed is sufficiently low, for example when the peripheral speed of the rotor is less than 70 m/s, the presence of tangential bridges may suffice to ensure the cohesion of the rotor.

The rotor magnetic mass may comprise at least one pole piece independent of the rest of the rotor magnetic mass. The term “independent” should be understood as meaning that the pole piece is not formed in one piece with the rest of the laminations. Thus, in this case, the rotor mass does not have tangential bridges as defined above. The pole piece may be kept secured to the rotor mass by any other means, notably an added means, for example by a longitudinal tie rod that passes through it and is fastened to one or more end plates of the rotor.

The rotor may also comprise at least one tie rod for holding the pole piece. The tie rod may be configured to pass through the pole piece and to be fastened to one or more end plates of the rotor.

The rotor may comprise at least one end plate, better still two end plates, to which the spacers and possible tie rods may be fastened, if necessary. The rotor may also comprise one or more intermediate plates that are disposed in the magnetic mass, that is to say in the stack of magnetic laminations of the rotor magnetic mass.

Rows of Permanent Magnets

The permanent magnets may be disposed in concentric rows, notably in two concentric rows, for example each disposed in a housing common to all the magnets in the row. The rows may each be V-shaped or U-shaped. The term “row” denotes a succession of at least two permanent magnets. A row is not necessarily linear in any case. Instead, a row may be U-shaped or V-shaped.

This disposition in several concentric rows makes it possible to improve the concentration of the flux without necessarily having to increase the size of the housings or the quantity of permanent magnets that are necessary to obtain an equivalent flux.

The disposition of the magnets in rows makes it possible to obtain high saliency in each pole of the machine. The machine is thus a motor having high saliency torque, also referred to as a synchronous reluctance motor. The term “saliency of a pole” means that the reluctance varies along the pole in the air gap during the rotation of the rotor.

In one exemplary embodiment, the permanent magnets are disposed in Vs oriented toward the air gap. For one and the same pole, a row of permanent magnets thus comprises two lateral branches and does not have a central branch. The magnets of the lateral branches are in this case disposed in the lateral branches of the housing. The housing may be U-shaped, with a central branch which in this case does not have a magnet.

The Vs of one and the same pole are disposed concentrically; in other words, the Vs of one and the same pole are nested in one another.

The Vs are oriented toward the air gap. The term “V oriented toward the air gap” means that the V is open in the direction of the air gap. Each lateral branch of a V may be formed by a single permanent magnet. In a variant, each lateral branch of a V is formed by more than one permanent magnet, notably by two magnets that form, for example, each branch of the V. Such segmentation of the magnets may make it possible to improve the circulation of the flux in the rotor mass and/or to introduce bridges so as to stiffen the latter.

A branch of a V may be formed of several magnets, for example two magnets. Two magnets in a branch of the V may be aligned. In a variant, the magnet or magnets forming a branch of a V may each extend along an axis, the two axes making an angle α between one another. This angle α may be between 0° and 45°.

At least one row of permanent magnets may have no central magnet, or all the rows of a pole have no central magnet. The term “central magnet” means a magnet disposed on the radial axis of the corresponding pole. Thus, in one variant embodiment, the rows only comprise permanent magnets that are each disposed entirely on one side of the longitudinal axis of the corresponding pole.

Shared Permanent Magnets

The permanent magnets may define magnetic poles of the rotor, namely a first pole and a second pole adjacent to the first pole, the first and second poles having different polarities, permanent magnets inherent to the first pole contributing only to the polarity of the first pole and at least one shared permanent magnet contributing in part to the polarity of the first pole and in part to the polarity of the second pole.

In this embodiment, the rotor comprises at least one permanent magnet shared between two consecutive poles. The term “shared permanent magnet” means a permanent magnet that is common to the definition of two consecutive poles of the rotor. This magnet may thus be disposed on an interpolar axis. At least one permanent magnet defining said first pole also defines the second pole of the rotor that is adjacent to the first pole. The limit between the two consecutive poles passes through at least one permanent magnet.

When the permanent magnets are disposed in rows, the first pole of the rotor may be defined by at least one first row of inherent permanent magnets and by at least one second row of shared permanent magnets, said second row also defining, at least in part, the second pole of the rotor that is adjacent to the first pole.

In other words, the second row of permanent magnets simultaneously defines each of the two consecutive poles of the rotor between which it is situated. The shared permanent magnet belongs to the second row of permanent magnets.

Moreover, in this case, each pole may be said to be defined by a non-integer number of rows, being equal to the number of first rows plus a half; in other words, the second row defining said pole counts for half, given the use of the magnets in the second row to simultaneously define two consecutive poles of the rotor.

Thus, for a given diameter of the rotor, the number of rows per pole may be higher, such that the total quantity of permanent magnets may be greater, with equivalent bulk.

Moreover, the saliency ratio may be increased thereby, since the magnets shared between two consecutive poles may form a barrier to the circulation of the direct magnetic flux without affecting the magnetic flux in quadrature. Given a constant quantity of permanent magnets, the electromotive force may be greater and have fewer harmonics, since the passage of the induction through zero on the interpolar axis is more restricted angularly.

By virtue of the disposition of the magnets in the rotor mass, sufficient levels of induction are obtained in the air gap, even with relatively low polarity of the rotor, for example less than 6, with magnets having high energy per unit volume, such as magnets made of rare earths, not necessarily being used but, by contrast, magnets having low energy per unit volume, for example those made of ferrite. The cost of the rotor may thus be reduced thereby. Moreover, the polarity of the rotor may be reduced if the application so requires. Specifically, the rotor according to the invention makes it possible to increase the level of induction in the air gap without increasing the polarity and by using low energy density magnets.

Permanent Magnets

The permanent magnets preferably have a rectangular shape in cross section. In a variant, the width of a magnet measured in cross section perpendicularly to the axis of rotation may narrow when facing toward the air gap. The permanent magnets may have a trapezoidal overall shape in cross section. In a further variant, the magnets may have a curved cross section, for example in the form of a ring sector.

The permanent magnets may have a width of between 4 and 20 mm. At least one magnet in a first row, or at least half the magnets in a first row, or all the magnets in a first row, may have a width greater than 4 mm, better still greater than 8 mm, or even greater than 12 mm.

The magnet or magnets in a second row of permanent magnets may be the same width as the magnets in a first row, or, in a variant, have a different width, notably a greater width. Thus, at least one shared permanent magnet may be wider in cross section than an inherent permanent magnet, being for example twice as wide as an inherent permanent magnet. Such a configuration may make it possible to minimize, or better still to eliminate, any circulation of the flux between two adjacent poles, notably direct magnetic flux, without affecting the magnetic flux in quadrature, and thus to reduce the harmonic content. The efficiency may be improved thereby. In addition, the number of material bridges, notably of radial bridges, may be reduced thereby, such that the electromagnetic torque is improved.

The first pole may comprise a single first row, or each of the poles of the rotor may comprise a single first row.

In a variant, said first pole may comprise at least two first rows, or each of the poles of the rotor may comprise at least two first rows, notably two, or three, or even more. In one embodiment, the first pole comprises two first rows. Each of the poles of the rotor may comprise two first rows.

The rotor may have a number of poles of between 2 and 12, better still between 4 and 10. The number of poles of the rotor may be less than or equal to 8, or less than or equal to 6, being for example equal to 4 or 6.

The permanent magnets may be made of ferrites or with rare earths or with any other type of magnetic material. The permanent magnets may in particular be made at least partially of ferrite. It is possible for example for them not to contain rare earths, or at the very least to contain less than 50% by mass of rare earths. The disposition of the magnets makes it possible to concentrate the flux of the magnets and to obtain advantageous performance with ferrite magnets.

Housings

A housing may have a cross section with a rectangular overall shape. At least one housing may extend radially along a length greater than the radial length of the corresponding magnet, in cross section. The shape of the housing in cross section may be chosen so as to optimize the induction waveform in the air gap. By way of example, at least one end of the housing may have a rectangular, triangular or curved shape in cross section perpendicularly to the axis of rotation.

The rows may have a decreasing length in the direction of the air gap, the longest being closer to the axis of rotation and the shortest by the air gap.

The disposition of the housings and/or of the permanent magnets in a row is preferably symmetrical with respect to the radial axis of the pole.

The housings may have a constant or variable width along their longitudinal axis, in a plane perpendicular to the axis of rotation of the rotor.

Rotor Mass and Shaft

The rotor may comprise a shaft extending along the axis of rotation, the rotor magnetic mass being disposed on said shaft. The shaft may be made of a magnetic material, advantageously making it possible to reduce the risk of saturation in the rotor mass and to improve the electromagnetic performance of the rotor. The shaft may comprise a magnetic sleeve in contact with the rotor mass, the sleeve being mounted on a magnetic or non-magnetic spindle.

In a variant, the rotor may comprise a non-magnetic shaft on which the rotor mass is disposed. The shaft may be made at least in part from a material from the following list, which is not limiting: steel, stainless steel, titanium or any other non-magnetic material. The rotor mass may, in one embodiment, be disposed directly on the non-magnetic shaft, for example without an intermediate rim. In a variant, notably when the shaft is not non-magnetic, the rotor may comprise a rim that surrounds the shaft of the rotor and bears against the latter.

The rotor mass extends along the axis of rotation and is disposed around the shaft. The shaft may comprise torque transmitting means for driving the rotor mass in rotation.

The rotor mass may be formed from a stack of magnetic lamination layers. The stack of magnetic lamination layers may comprise a stack of magnetic laminations, each in one piece, each lamination forming a layer of the stack.

A lamination may comprise a succession of sectors connected by tangential material bridges.

Each rotor lamination is for example cut out of a sheet of magnetic steel, for example steel with a thickness of 0.1 to 1.5 mm. The laminations may be coated with an electrically insulating varnish on their opposing faces before they are assembled within the stack. The insulation may also be obtained by a heat treatment of the laminations.

In a variant, the rotor mass may comprise a plurality of pole pieces assembled on the shaft of the rotor, which is preferably non-magnetic in this case. Assembly may be effected by dovetails on a shaft of the machine, or in a variant by means of tie rods as mentioned above. Each pole piece may comprise a stack of magnetic laminations.

The distribution of the housings is advantageously regular and symmetrical, making it easier to cut out the rotor lamination and facilitating mechanical stability after cutting when the rotor mass is made up of a superposition of rotor laminations.

The number of housings and magnets depends on the polarity of the rotor. The rotor mass may comprise any number of housings, for example between 4 and 96 housings, better still between 8 and 40 housings, or even between 12 and 32 housings.

The magnets may be embedded in the rotor mass. In other words, the magnets are covered by portions of magnetic laminations at the air gap. The surface of the rotor at the air gap may be defined entirely by the edge of the layers of magnetic laminations and not by the magnets. The housings therefore do not lead radially toward the outside.

The rotor mass may comprise one or more holes in order to lighten the rotor, allow it to be balanced or to assemble the rotor laminations of which it is made up. Holes may allow the passage of tie rods that keep the laminations secured together.

The layers of laminations may be snap-fastened to one another.

The housings may be filled at least partially with a non-magnetic synthetic material. This material may lock the magnets in place in the housings and/or increase the cohesion of the set of laminations.

If necessary, the rotor mass may comprise one or more reliefs that help to position the magnets properly, notably in the radial direction.

The rotor mass may have a circular or multilobe outer contour, a multilobe shape possibly being useful for example for reducing torque undulations or current or voltage harmonics.

The rotor may or may not be mounted with an overhang.

The rotor may be made of several pieces of rotor that are aligned in the axial direction, for example three pieces. Each of the pieces may be offset angularly with respect to the adjacent pieces (known as a “step skew”).

Manufacturing Method and Machine

A further subject of the invention, independently or in combination with the above, is a method for manufacturing a stator, notably a stator as defined above, wherein the two following steps are implemented in succession:

(i) disposing windings in the slots in a ring gear of the stator, and

(ii) attaching a yoke to the ring gear of the stator.

In step (i), at least one winding may be disposed in two different, non-consecutive slots in the ring gear of the stator.

The windings used in step (i) may be obtained by prior deformation of shuttles having two parallel long sides and two semicircular ends. Said deformation may consist in spacing the two long sides of the shuttles perpendicularly apart from one another so as to obtain the windings.

A further subject of the invention, independently or in combination with the above, is a machine for manufacturing a stator for implementing the above-described method, comprising tools for simultaneously deforming several shuttles, or all the shuttles, so as to obtain the windings of a single stator.

The machine may be configured to allow the simultaneous fitting of several windings, or of all the windings, on the ring gear. Given the nesting of the windings on the ring gear, the speed of manufacturing the stator may thus be improved considerably.

The invention may be understood better from reading the following detailed description of non-limiting exemplary embodiments thereof and from studying the appended drawing, in which:

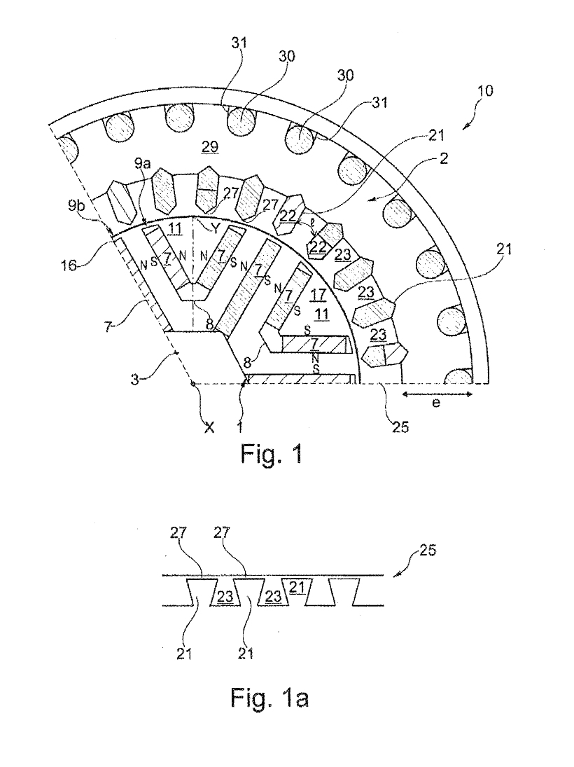

FIG. 1 schematically and partially shows a cross section through a machine comprising a stator produced in accordance with the invention,

FIG. 1a schematically shows a metal strip intended to form a ring gear,

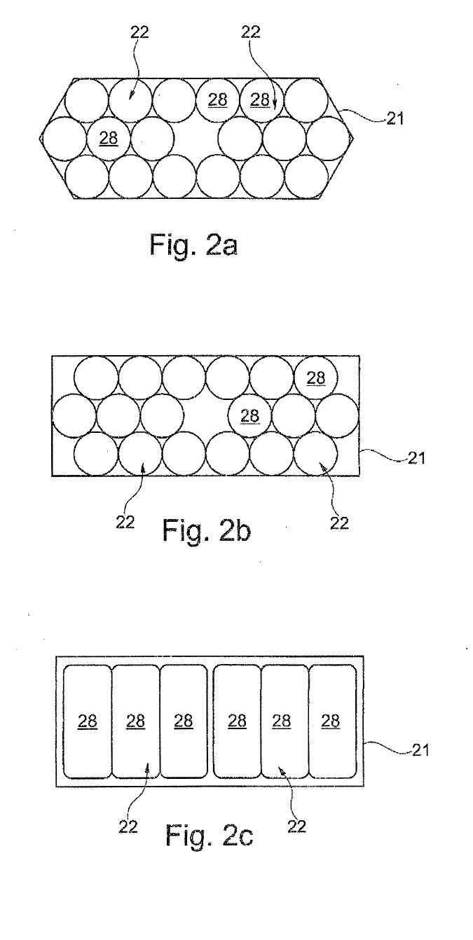

FIGS. 2a to 2c illustrate the disposition of the electrical conductors in the slots,

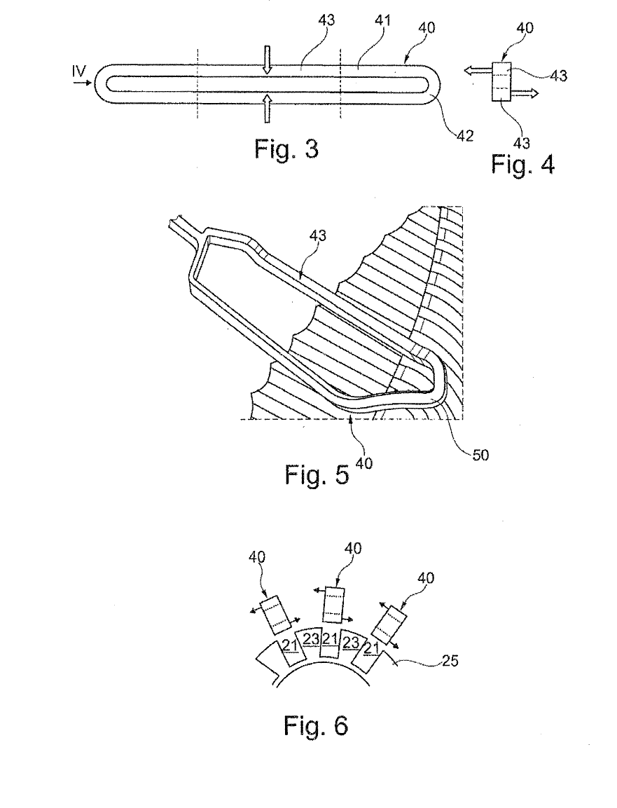

FIG. 3 is a schematic and partial view of a shuttle,

FIG. 4 is a view along the arrow IV in FIG. 3,

FIG. 5 is a perspective, schematic and partial view of a winding, and

FIG. 6 is a schematic and partial view illustrating the manufacture of the stator.

FIG. 1 illustrates a rotary electric machine 10 comprising a rotor 1 and a stator 2. The stator makes it possible to generate a rotary magnetic field for driving the rotor 1 in rotation, within the context of a synchronous motor, and in the case of an alternator, the rotation of the rotor induces an electromotive force in the windings of the stator.

Stator

The stator 2 comprises distributed windings 22, as illustrated, which are disposed in the slots 21 formed between the teeth 23 of a ring gear 25. The slots are closed in the direction of the air gap by tangential bridges 27 that connect two consecutive teeth of the ring gear 25 together. Moreover, the stator comprises a yoke 29 attached to the ring gear 25. The yoke 29 is equipped with semicircular longitudinal ribs 31 that are intended to accommodate ducts 13 for the circulation of a cooling liquid.

The windings 22 are disposed in a distributed manner in the slots 21 and have electrical conductors 28 that are disposed in an arranged manner in the slots 21.

The slots 21 have mutually parallel radial edges in the example described and have a hexagonal shape in cross section, being diamond-shaped. The electrical conductors in these slots have a circular cross-sectional shape. The arrangement of the latter is a hexagonal arrangement, as illustrated in FIG. 2a. The tangential bridges 27 have a width which is not constant but decreases and then increases. The filling rate is in this case more than 100%.

The ring gear 25 is produced by helically winding up a rectilinear strip of teeth connected by tangential bridges 27, as illustrated in FIG. 1a. The teeth 23 of the rectilinear strip form the slots 21 between one another which have converging edges, the edges of the slots being parallel to one another when the strip is wound up on itself to form the ring gear.

In one variant embodiment, the slots can have a rectangular cross-sectional shape, still with electrical conductors with a circular cross-sectional shape, as illustrated in FIG. 2b.

In yet another variant embodiment, the slots can have a rectangular cross-sectional shape, but with electrical conductors with a rectangular cross-sectional shape, as illustrated in FIG. 2c.

The stator 2 illustrated comprises more precisely 27 slots that are distributed in six poles, with a tooth pitch of ⅘. In other words, it comprises 1.5 slots per pole and per phase.

Each slot 21 comprises 18 electrical conductors in the example described, which are in this example enameled wires having a diameter of 1.32 mm. Filling is improved thereby and a better resulting torque is obtained. The conventional filling rate is in this case more than 94%. The term “conventional filling rate” means the ratio between the cumulative sum of the squares of the diameters of the conductors and the useful cross section of the slot.

Each slot comprises two stacked windings, and therefore two winding stages.

The thickness e of the yoke is relatively large compared with known machines, since the height of the slot has been able to be reduced by virtue of the increase in the filling rate.

Furthermore, the same goes for the width/of the teeth.

A significant reduction in the consumption of electrical field (or ampere-turns) at the stator, or a significant increase of the flux passing through the stator, may thus be obtained.

Rotor

The rotor 1 shown in FIG. 1 comprises a rotor magnetic mass 3 extending axially along the axis of rotation X of the rotor, this rotor mass being formed for example by a set of magnetic laminations stacked along the axis X, the laminations being for example identical and superposed exactly. They may be held together by clip-fastening, by rivets, by tie rods, welds or any other technique. The magnetic laminations are preferably made of magnetic steel. All grades of magnetic steel may be used.

The rotor mass 3 comprises a central opening 5 for mounting it on a shaft. The shaft may, in the example in question, be made of a non-magnetic material, for example of non-magnetic stainless steel or of aluminum, or else be magnetic.

The rotor 1 comprises a plurality of permanent magnets 7 disposed in housings 8 in the rotor magnetic mass 3. In the example described, the permanent magnets 7 are disposed in two rows 9a, 9b defining the six poles 11 of the rotor. Each of the rows 9a, 9b comprises two permanent magnets 7, which are disposed one on each side of a radial axis Y of said pole 11.

The permanent magnets 7 are both disposed in a common housing 8 that is formed in the rotor magnetic mass 3 and passed through by the radial axis Y of the pole. This housing 8 extends from the air gap in the direction of the shaft, and then back toward the air gap. The housings 8 are V-shaped or U-shaped.

The permanent magnets 7 are disposed in Vs oriented toward the air gap. For one and the same pole, a row of permanent magnets thus comprises two lateral branches. The Vs of one and the same pole are disposed concentrically; in other words, the Vs of one and the same pole are nested in one another. In the example described, a V has a shape that flares toward the air gap, the lateral branches of the V not being parallel to one another. None of the rows of a pole have a central magnet.

The permanent magnets 7 have a rectangular shape in cross section. They may be made of ferrite or, alternatively, of rare earths, for example of the neodymium type or the like. Preferably, the magnets are made of ferrite.

In the example illustrated in FIG. 1, the rotor comprises tangential bridges 16 formed between a housing 8 and the air gap. It does not have any material bridges other than tangential material bridges and in particular does not have radial bridges.

The rotor magnetic mass 3 comprises, for each pole, a pole piece 17 connected to the rest of the magnetic mass by tangential bridges 16 that are formed between each of the two ends of the housing and the outer surface of the rotor.

In one variant embodiment, the rotor magnetic mass 3 could comprise pole pieces 17 that are independent of the rest of the rotor magnetic mass.

In the example described, the polarity of the first pole of the rotor is defined by a first row 9a (or several first rows 9a) of inherent permanent magnets 7 and by a second row 9b of shared permanent magnets 7, said second row 9b likewise defining in part the polarity of the second pole of the rotor that is adjacent to the first pole. The shared permanent magnet 7 that contributes to the polarity of the first pole likewise contributes to the polarity of the second pole of the rotor that is adjacent to the first pole. The second row 9b of permanent magnets 7 thus simultaneously defines the polarities of each of the two consecutive poles of the rotor between which it is situated. The limit between the two consecutive poles passes through at least said shared permanent magnet 7.

In the example illustrated in FIG. 1, each of the poles of the rotor comprises a single first row. The first row of each of the poles is disposed in a V shape in these examples, the concavity of the row being oriented toward the apex of the pole, that is to say toward the air gap. It could of course be different, and the rotor could comprise for example two first rows, or more.

Stator Manufacturing Method and Machine

The stator is obtained by means of the manufacturing method which will now be described in detail.

In a preparatory step, shuttles 40 are manufactured by winding up electrical conductors in the form of an ancient stadium track, with bends that are as tight as possible, as illustrated in FIG. 3, so as to have two parallel long sides 41 and two semicircular ends 42.

Next, two rectilinear portions 43 of the two parallel long sides 41 of the shuttle 40 are spaced perpendicularly apart from one another, as illustrated in FIG. 4, said rectilinear portions 43 being intended to form the active portions of the final winding 22, that is to say to be inserted into the slots 21, the rest forming the coil heads 50. The winding thus obtained is illustrated in FIG. 5.

Finally, the two following steps are implemented in succession:
(i) first of all, the windings 22 obtained from the shuttles 40 are disposed in the slots 21 in the ring gear 25 of the stator 2, and
(ii) the yoke 29 is attached to the ring gear 25 of the stator 2.

In step (i), each winding 22 is disposed in two different, non-consecutive slots in the ring gear of the stator, so as to obtain a stator with distributed windings.

This method may be implemented by means of a machine for manufacturing a stator, comprising tools for simultaneously deforming several shuttles, or all the shuttles, so as to obtain the windings of a single stator.

The machine may be configured to allow the simultaneous fitting of several windings, or of all the windings, on the ring gear, as illustrated in FIG. 6.

The assembly obtained may be impregnated before being inserted into the annular yoke 29 also prepared.

Of course, the invention is not limited to the exemplary embodiments which have just been described.

The expression “comprising a” should be understood as being synonymous with “comprising at least one”.

1. A stator for a rotary electric machine, comprising:
a ring gear having teeth that define slots between one another that are open radially toward the outside,
windings that are disposed in a distributed manner in the slots, having electrical conductors that are disposed in an arranged manner in the slots, and
a yoke attached to the ring gear.

2. The stator as claimed in claim 1, wherein at least one slot is closed on the air gap side by a tangential bridge that connects two consecutive teeth of the ring gear together.

3. The stator as claimed in claim 1, wherein at least one slot has edges that are radially parallel to one another.

4. The stator as claimed in claim 1, wherein at least one slot has a rectangular or hexagonal cross.

5. The stator as claimed in claim 1, wherein at least one tooth have a trapezoidal overall shape in cross section.

6. The stator as claimed in claim 1, wherein the electrical conductors present in the slots have a circular or rectangular section.

7. The stator as claimed in claim 1, wherein the ring gear is produced by helically winding up a strip of teeth connected by tangential bridges, the teeth of the strip in the rectilinear state forming slots between one another that have convergent edges, the edges of the slots being substantially parallel to one another when the strip is wound up on itself to form the ring gear.

8. A rotary electric machine comprising a stator as claimed in claim 1 and a permanent magnet rotor.

9. A method for producing a stator, wherein the two following steps are implemented in succession:
(i) disposing windings in the slots in a ring gear of the stator, and
(ii) attaching a yoke to the ring gear of the stator.

10. The method as claimed in the claim 9, wherein, in step (i), at least one winding is disposed in two different, non-consecutive slots in the ring gear of the stator.

11. The method as claimed in claim 9, wherein the windings used in step (i) are obtained by prior deformation of shuttles having two parallel long sides and two semicircular ends.

12. The method as claimed in claim 9, wherein said deformation consists in spacing the two long sides of the shuttles perpendicularly apart from one another so as to obtain the windings.

13. A machine for manufacturing a stator for implementing the method as claimed in claim 9, comprising tools for simultaneously deforming several shuttles, so as to obtain the windings of a single stator.

14. The machine as claimed in claim 13, which is configured to allow the simultaneous fitting of several windings, on the ring gear.
